(19) United States
(12) Patent Application Publication
(10) Pub. No.: US 2009/0273184 A1
(43) Pub. Date: Nov. 5, 2009

(54) SELF RESTRAINED JOINT FOR DUCTILE IRON PIPE AND FITTINGS

(76) Inventors: Michael Wright, Fort Worth, TX (US); Randall Chinchilla, San Jose (CR)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 12/112,648

(22) Filed: Apr. 30, 2008

(51) Int. Cl. F16L 19/04; F16L 17/00

(52) U.S. Cl. 285/337; 277/616

(57) ABSTRACT

A combination sealing and restraint system for an as-cast ductile iron pipe systems. A ductile iron pipe/fitting with a bell end has an as-cast profile formed therein for receiving both a gripping ring and a sealing ring in spaced apart locations. The gripping ring is installed within a first recess provided as a part of the as-cast profile in a post-casting step. The sealing ring is also installed within a second, spaced recess after the casting operation is complete. The sealing ring can be a dual durometer gasket which can be flexed and inserted into the profile. The same type bell end can be provided as an adapter which converts a traditional mechanical joint restraint to an internal gripping and restrain system.

### BACKGROUND OF THE INVENTION

A. Field of the Invention:

The present invention relates generally to the field of pipe connections and to components used in the pipeline construction industry. More particularly, this invention relates to a combination sealing and restraint system for use in “as-cast” ductile iron pipeline systems.

B. Description of the Prior Art

Pipes are commonly used for the conveyance of fluids under pressure, as in city water lines. They may also be used as free-flowing conduits running partly full, as in drains and sewers. Pipes for conveying water in appreciable quantities have been made of steel, cast iron, concrete, vitrified clay, and most recently, plastic including the various polyolefins and PVC Ductile Iron is a high strength, tough material which has traditionally been used in water and wastewater systems in all 50 states of the United States and in many other areas of the world. In the United States alone, it has been in continuous use in hundreds of municipal utility systems for more than a century.

In many applications where lengths of pipe are joined in telescoping relationship, the spigot end of one pipe is inserted into the socket end of the engaging pipe at a pipe joint or “coupling.” The socket end has an opening large enough to receive the spigot end of the mating pipe. A gasket is typically present within the socket end of the pipe which is intended to prevent leakage of fluid from the joint by forming a seal between the two pipe sections. Piping systems of the above type also typically include “fittings” as that term is defined in the industry. A fitting is a term which will be familiar to those in the relevant industries and includes a piece, often curved or at an angle, as a coupling, an elbow, a valve, a Tee, etc. used for connecting lengths of pipe or as an accessory to a pipe in a piping system for conveying fluids. Exemplary “as cast” ductile iron pipe fittings are shown, for example, in the Tyler/Union Utilities Mini-Catalogue, May 2001, on pages 2-3, as the “Mechanical Joint C153 Ductile Iron Compact Fittings.” These fittings are merely intended to be exemplary, as there are a number of other commercial sources for such pipe fittings.

In addition to pipes and fittings, there are other components in a pipeline system which are placed in fluid communication with a length of pipe, requiring a sealed coupling or joint. For example, there are hydrant tees and valves which are commonly used in most municipal water systems. As an example of such components, American AVK is a leading manufacturer of gate valves, fire hydrants, and accessories for the water, wastewater, fire protection, and irrigation industries and company catalogues illustrate a variety of these general types of products.

One important consideration in piping systems of the above type, whether in a straight run of pipe or at a fitting, is to provide adequate sealing at the pipe joints or couplings. In addition to the necessity of providing effective sealing, another important design requirement exists when it becomes necessary to join the pipe components in a restrained manner. This is usually desired in order to prevent the pipe components from separating due to thrust forces that often occur when the pipeline is subjected to internal or external pressures, changes in direction or elevation of the pipeline, and sometimes when earthquakes or tremors or other external factors come into play.

Thus, in a straight section of a ductile iron pipeline, the hydrostatic forces are generally balanced. Wherever the pipeline changes direction or diameter, such as at a bend, tee or a reducer, however, the hydrostatic forces create an unbalanced thrust force in the line. This unbalanced thrust force can cause the line to move or its joints to separate unless the thrust force is counterbalanced in some manner. Where there are only gradual changes of direction in the line, the lateral thrust forces are normally counterbalanced by the friction between the pipe and the soil along the length of piping, and joint restraint is not normally required. However, when higher pressures, poor soil conditions or significant changes of direction or diameter are encountered, the thrust forces may be too great to be resisted by the soil surrounding an unrestrained joint. In the past, these unbalanced thrust forces have commonly been counterbalanced with thrust blocks, restrained pipe joints, or a combination of the two.

Conventional ductile iron pipe joints are push-on type joints or traditional bolted mechanical joints, neither of which is restrained. These joints do not offer any significant resistance to joint separation. For example, One of the most common devices for forming a sealed joint in straight runs of pipe referred to above is the “mechanical joint” or “MJ”. There, the bell end of an iron pipe section has a cast-on flanged portion on the pipe exterior. The spigot end of a second iron pipe is fitted with a slidable gland fitting and a gasket that is conically shaped such that one face of the gasket is diametrically larger than the second face of the gasket. The conically shaped gasket is positioned between the gland fitting and the spigot end of the pipe with the smaller, second face of the gasket being closer to the spigot end than the larger, first face of the gasket. The gland fitting has a plurality of apertures for receiving standard bolts. The joint is formed when the spigot is axially inserted into the bell, and the gland fitting and the flanged portion are bolted together, causing the lip of the gland fitting to compress the gasket thus sealing the two pipe pieces.

While the “internal” gasket used in the traditional MJ design for ductile iron pipe served to seal the joint, the gasket did not feature a cooperating “restraint” feature in order to assure the greater integrity of the joint of pipe. Instead, it was necessary to utilize a cumbersome external mechanical restraint system made up of the flange, bolts, screws, etc., as discussed above. Also, when the pipe component being joined was a fitting rather than a straight run of pipe, there was less room available on the exterior of the fitting to accept the various parts (flanges, bolts, screws, etc.) that were necessary to make up the MJ type restraint.

In order to meet the need for a restrained joint of the above type, a number of companies in the industry have worked to develop various forms of restrained joint products for ductile iron pipelines. These include, for example, the FAST-GRIP® and TR FLEX® restrained push-on joints, the FIELD LOK 350® gaskets used to restrain push-on TYTON® JOINTS, and the more recent MJ FIELD LOK® gaskets which are used to restrain mechanical joint pipe and fittings.

The Ductile Iron Pipe Research Association (DIPRA) has published the “Thrust Restraint Design for Ductile Iron Pipe,” a document of conservative design guidelines for the restraint of thrust forces in underground, pressurized, Ductile Iron piping systems. The DIPRA procedures are based on accepted principles of soil mechanics and provide formulas for determining thrust forces and the necessary restraint.

Thus, in spite of improvements in pipeline systems generally, a need continues to exist for an improved sealing and restraint system for ductile iron pipelines of the type which offers complimentary sealing and self-restraining features.

A need also exists for such a system which is cost-effective, easy to manufacture and easy to use in the field and which is dependable in operation.

A need also exists for such a system which effectively restrains ductile iron pipes and fittings, as well as hydrant tees and valves, against internal and external forces without the need for an external flange, bolts or associated restraining screw mechanisms.

### SUMMARY OF THE INVENTION

The present invention has as one object to provide a combination sealing and restraint system installed within a special profile formed within a mouth region located adjacent an end opening of an as-cast ductile iron pipe/fitting capable of both sealing and restraining the ductile iron pipe/fitting to a mating male pipe having an interior surface and an exterior surface. The same type sealing and restraint system can be installed within the mouth opening of a hydrant tee or flow line valve.

The preferred sealing and restraint system includes a gripping ring installed within a first recess provided as a part of the as-cast profile of the ductile iron pipe/fitting. The gripping ring is installed as a part of a post-casting operation, after the pipe/fitting body is cast at the foundry. The gripping ring has an inner circumferential surface and an outer circumferential surface, the inner circumferential surface having at least one row of teeth located thereon for engaging selected points on the exterior surface of the mating male pipe.

The sealing and restraint system also includes a sealing gasket having an annular gasket body at least a portion of which is made of a resilient elastomeric material, the annular gasket body having an inner circumferential region and an outer circumferential region. The sealing gasket is installed within a second spaced recess provided as a part of the as-cast profile within the mouth region of the ductile iron pipe/fitting so that the outer circumferential region forms a seal with the fitting mouth region and the inner circumferential region forms a sealing surface for a mating male pipe section. The sealing gasket is installed within the second spaced recess in a post-casting step after forming the pipe/fitting body. The sealing gasket and gripping ring are activated by internal hydraulic forces of fluids passing through the pipe/fitting body during use, the hydraulic forces serving to cause the gripping teeth on the gripping ring to engage the exterior surface of the mating male pipe.

The sealing gasket can be a dual durometer gasket which is formed with a relatively harder durometer region joined to a relatively softer durometer region, whereby the gasket can be flexed to allow it to be installed within the recess provided as a part of the as-cast profile. The gasket can also be a snap-fit gasket having an embedded reinforcing ring which is not easily bent or flexed by hand and which is of a diameter which is initially greater than the diameter of the mouth opening of the as-cast pipe/fitting, the gasket being installed by bending the gasket to an initially deformed shape.

The preferred gripping ring is a single piece, continuous ring formed of a hard metal and having a slit at one circumferential location which creates at least one gap, the gap being defined between two opposing faces of the gripping ring when the ring is in a relaxed state. The ring preferably has a special low-coefficient of friction coating applied thereto to allow it to properly seat in the pipe cast recess when hydrostatic pressure is applied to the pipe joint.

The mating male pipe which is used with the restraint system of the invention can be made of ductile iron or of a suitable plastic such as PVC.

The combination sealing and restraint system of the invention can also be provided as an adapter for connecting a ductile iron mechanical joint to a mating male pipe section. In that case, the adapter comprises a generally cylindrical ductile iron adapter body having an interior surface and an exterior surface. The interior surface includes the previously described combination sealing and restraint system which is installed within an as-cast profile provided within a mouth region located adjacent an end opening of the adapter body capable of both sealing and restraining the adapter body to a mating male pipe having an interior surface and an exterior surface. However, in this case, the cylindrical adapter body is provided with an external flange ring formed thereon as an integral part of the as-cast body of the adapter. The external flange ring has a plurality of bolt openings for receiving joining bolts which are used to join the adapter to a mating mechanical joint having a mating flange ring.

An improved method for forming a pipe joint is also shown in which the previously described combination sealing and restraint system is utilized. The special pipe/fitting with the combination sealing and restraint system is manufactured as has been described. Thereafter, a mating male pipe is installed within the end opening of the mouth region of the as-cast pipe/fitting by pushing the male pipe within the end opening. The sealing ring and gripping ring contact the external surface of the mating male pipe in use in order to both seal and restrain the mating male pipe and form a secure pipe joint. In those cases where the sealing and restraint system is provided as an adapter, the adapter body is first bolted to an existing ductile iron mechanical joint and thereafter a mating male pipe end is inserted within the mouth opening of the adapter to form a secure joint.

Additional objects, features and advantages will be apparent in the written description which follows.

### BRIEF DESCRIPTION OF THE DRAWINGS

FIG. 1 is a partial sectional view of an as-cast ductile iron pipe showing the combination sealing and restraint system of the invention in place within a mouth region of the pipe.

FIG. 2 is a partial sectional view similar to FIG. 1 of an adapter version of the combination sealing and restraint system of the invention.

FIG. 3 is a partial sectional view of a prior art mechanical joint of the type widely used in the waterworks industry.

FIG. 4 is a partial sectional view of a prior art push-on joint of the type used in the past in the industry.

### DETAILED DESCRIPTION OF THE INVENTION

The present invention deals with piping systems in general and particularly with piping systems of the type used in water, sewage and other municipal fluid conveyance systems. In the past, such pipelines were traditionally formed of a ferrous metal. By “ferrous metal” is meant iron and alloys of iron. For example, one type of ferrous metal which is commonly encountered in the water works industry is “ductile iron.” This particular type of metal is widely used because it offers a combination of a wide range of high strength, wear resistance, fatigue resistance, toughness and ductility in addition to the well-known advantages of cast iron-castability, machinability, damping properties and economy of production. It takes its name from the fact that it is “ductile” in nature, rather than being brittle, as was the case with earlier cast iron products and materials. Today, grades of ductile iron are available offering the option of choosing high ductility with grades guaranteeing more than 18% elongation, or high strength, with tensile strengths exceeding 120 ksi (825 MPa). Austempered ductile iron (ADI), offers even greater mechanical properties and wear resistance, providing tensile strengths exceeding 230 ksi (1600 Mpa).

Although plastic piping systems using polyolefins such as PVC are becoming ever increasingly popular, a great number of older pipelines exist with ductile iron pipe and pipe components. Also, new systems continue to be installed which are made of ductile iron. There is also the need to join components of “hybrid” systems which contain both ductile iron and plastic pipe and pipe components.

In forming a pipeline of ductile iron components, one end of each section of an as-cast section of pipe is provided with a “bell” at one end sufficient to join the next adjacent pipe section by receiving in the belled end the unenlarged or “spigot” end of the next adjacent length of pipe within the bell end opening. The inside diameter of the bell is formed sufficiently large to receive the spigot of the next section of pipe with sufficient clearance to allow the application of an elastomeric gasket or other sealing device designed to prevent leakage at pipe joints when a plurality of pipe lengths are joined to form a pipeline.

Straight runs of ductile iron pipe of the above type have, for many years, been joined by utilizing an elastomeric gasket which is compressed between the inside walls of the bell and the outside wall of a mating spigot end of the next pipe in a series of telescoped pipes. The gasket is typically retained within a groove or profile provided in the bell end opening of the female pipe section. However, as discussed above, one problem which exists is finding a way to “restrain” the assembled pipe joints so that the joint will not be separated due to internal or external pressure, due to changes in direction of the pipeline, or due to environmental factors such as earth movement.

As mentioned in the background discussion of the invention, the iron pipe industry has generally addressed the problem of providing a restrained pipe joint by utilizing an external sealing “gland” or flange, sometimes referred to as a “mechanical joint” or simply as an “MJ”. The MJ style restraint has worked satisfactorily in the past on straight runs of pipe. However, fittings typically do not present as large an exterior surface for receiving the various components needed to make up the MJ type restraint. Also, an internal combination sealing and restraint system would offer greater ease and speed of assembly in the field. Because the gripping components would be internal rather than external, there would be less opportunity for corrosion of the metallic components in use.

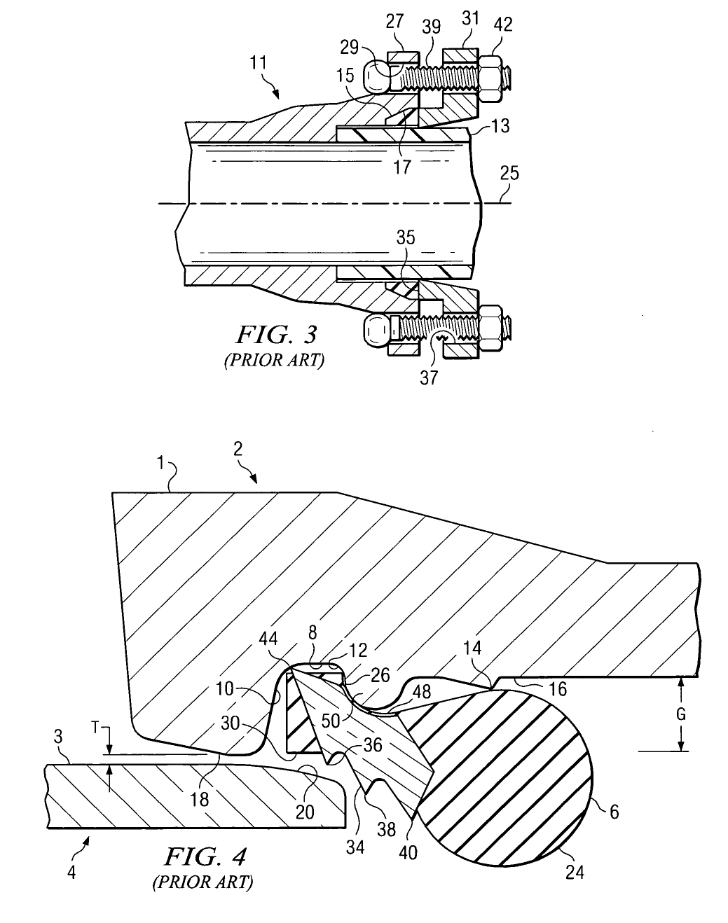

Turning to FIG. 3, there is shown a typical mechanical joint of the prior art. The joint shown in FIG. 3 is formed between a pipe bell end 11 of one ductile iron pipe and the plain spigot end 13 of a second ductile iron pipe. The second pipe 13 is inserted into the belled end 11 of the enclosing pipe. The inner surface of the pipe bell end 11 has a retainer groove 17 for retaining a gasket 15. The belled pipe end 11 also has a flanged region 27 which includes a plurality of apertures 29. A circumferential gland 31 is sized to be received about an outer surface of the mating male ductile iron pipe. The gland 31 has a forward lip portion 35 which contacts and compresses the body of the gasket 15 as the joint is assembled. The gland 31 also has a plurality of apertures 37 which are arranged to be aligned with the apertures in the flange collar region of the bell pipe end. Bolts 39 and nuts 41 are used to join the apertures of the bell pipe end and the gland as shown in FIG. 3.

While the mechanical joint illustrated in FIG. 3 has been utilized for a number of years in the industry, it is somewhat cumbersome and time consuming to assemble. Additionally, the external metallic components are subject to wear, damage and corrosion. As mentioned above, it maybe too bulky for use on some fittings. The present invention, therefore, has particular application to as-cast “fittings” which are used to make up a joint between two plain end pipe sections. However, the term “pipe/fitting” is used in the discussion which follows because the principles of the invention easily apply to either type device. By “as-cast” is meant that no additional machining is involved to form the bell, as with traditional systems. As-cast fittings of the type under consideration are commercially available from a number of sources, for example, the Tyler Pipe/Utilities Division of Union Foundry Company located in Anniston, Ala., as previously mentioned in the Background discussion.

FIG. 4 shows another prior art joint or coupling for ductile iron pipe of the “push-on” variety. This coupling uses a specially designed gasket to form a joint between a pipe bell end 1 of one pipe 2 and a plain or spigot end 3 of a second pipe 4. The inner surface of pipe bell 1 has a retainer groove 8 bounded by a front wall 10 and retainer wall 12, and a compression rib 14 which extends radially inwardly from a sealing wall 16. In addition, the bell has a throat portion 18 which extends radially inwardly and joins the front wall 10. As the joint is assembled the throat 18 guides the plain end 3 until the beveled end 20 contacts the conical inner face (not shown) of the gasket 6. The wedging action between the beveled end 20 and the conical face compresses the sealing bulb portion 24 of the gasket between the plain end 3 and the compression rib 14 and the sealing wall 16. The retainer wall 12 of the bell inner surface engages the retainer shoulder 26 of the gasket to prevent the gasket from dislodging during assembly of the joint.

In the particular prior art push-on connection shown in FIG. 4, a series of metal segments 34 have been inserted into the body of the gasket. The segments are spaced apart equally in a circumferential direction around the periphery of gasket 6. The metal segment 34 has teeth 36, 38, 40 and 44 extending beyond the heel portion 30 of gasket 6 toward the interior of the gasket. Teeth 36, 38, 40 and 44 are designed to bite into the outer surface of spigot 3 when pipe 4 is inserted into the bell end 1 of pipe 2. The back or outer face of gasket 6 has a groove 48 lying between heel portion 30 and sealing portion 24 of gasket 6. Groove 48 receives a bead 50 of bell 1. Gasket 6 can pivot partially around bead 50 when spigot 3 is moving into or out of bell 1.

The above described mechanical joint or “MJ” and the above “push-on” coupling are typical of the types of common implementations of traditional restrained joint technology used in industry today. Yet each system continues to have certain drawbacks. The present invention is intended to address many of the shortcomings present in the traditional restrained joint systems of the type described. In the discussion which follows, the invention will be primarily described with respect to ductile iron pipelines where one length of ductile iron pipe is being joined to a subsequent length of ductile iron pipe and where both pieces of pipe are formed of iron. However, those skilled in the art will realize that many of the principles involved would apply to “hybrid” systems in which the mating male pipe could also be formed of another material, such as a suitable plastic such as PVC or a suitable polyolefin such as polyethylene. Such “hybrid” systems are becoming increasingly common in use in the rehabilitation of existing ductile iron pipe lines. The same type combination sealing and restraint to be described could also be used in the mouth region of a ductile iron fitting and would operate in the same manner in forming a secure joint with a mating male pipe section. Thus, in the discussion which follows, the terms “pipe” and “pipe/fitting” are intended to cover, in addition to pipes and fittings, other components in a pipeline system which are placed in fluid communication with a length of pipe, requiring a sealed coupling or joint. For example, there are hydrant tees and valves which are commonly used in most municipal water systems. As has been mentioned, American AVK is a leading manufacturer of gate valves, fire hydrants, and accessories for the water, wastewater, fire protection, and irrigation industries and company catalogues illustrate a variety of these general types of products.

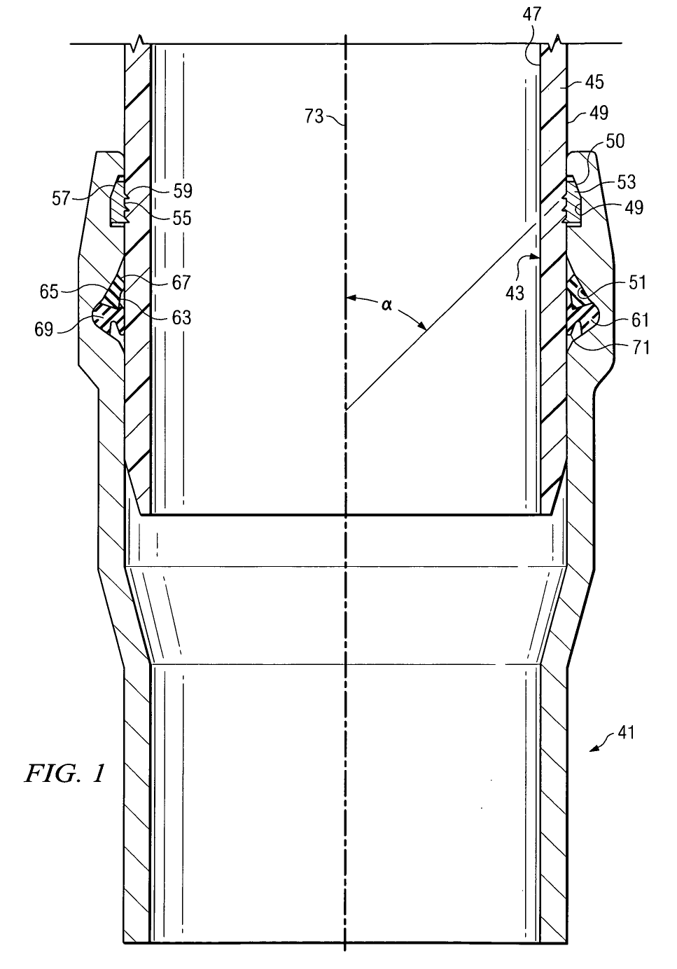

FIG. 1 illustrates an as-cast ductile iron pipe 41 which has installed therein the combination sealing and gripping restraint system of the invention. The combination sealing and restraint system is installed within a special as-cast profile provided within a mouth region 43 located adjacent an end opening of the body of the as-cast ductile iron pipe/fitting and is capable of both sealing and restraining the ductile iron pipe 41 to a mating male pipe 45 having an interior surface 47 and an exterior surface 49.

The special profile which is formed in the mouth region of the pipe 41 during the casting process at the foundry includes a first recess 49 and a spaced-apart second recess 51. A gripping ring 53 is installed within the first recess 49 provided as a part of the as-cast profile of the ductile iron pipe. The gripping ring is installed after the casting process at the foundry. The ring must be installed in a post-casting step because it must be able to move separately from the bell body within the recess area and thus cannot be part of the bell itself.

The ring 53 is also preferably coated with a low-coefficient of friction synthetic coating. This coating is preferably an AquaArmor® inner coat to which is applied a top coat of a suitable synthetic polymer. Coating of the ring could not be done if the ring was cast into the body of the bell at the foundry. The AquaArmor® coating is described in patent publication no. 20070196585, “Method of Applying a Phenolic Resin Corrosion Protective Coating to a Steel Component”, published Aug. 23, 2007. There, a method is shown for corrosion protecting both ductile iron and steel components in which a surface of the component is coated with a corrosion resistant coating which is an aqueous phenolic resin dispersion. The component is dipped in a bath of the corrosion resistant coating and then baked, dried and cooled. An electrostatic powder coating can be applied over the base phenolic resin coating for added corrosion protection and durability.

The preferred top coat which is applied to the gripping ring 53 is a synthetic polymeric coating. The selected synthetic polymer is preferably thermoplastic and can be selected from such materials as polyvinyl chloride, fluoroplastic polymers, nylon, and the like, depending upon the end application of the pipe joint. The preferred coatings are fluoroplastic polymers, sometimes referred to as “fluoroelastomers.” These materials are a class of paraffinic polymers that have some or all of the hydrogen replaced by fluorine. They include polytetrafluoroethylene, fluorinated ethylene propylene copolymer, perfluoroalkoxy resin, polychloro-trifluoroethylene copolymer, ethylene-tetra-fluoroethylene copolymer, polyvinylidene fluoride and polyvinyl fluoride. Fluoroplastics have a low coefficient of friction, especially the perfluorinated resins, giving them unique nonadhesive and self lubricating surface qualities.

One particularly preferred polymer for the top coat is polytetrafluoroethylene (PTFE). This material is a completely fluorinated polymer manufactured by free radical polymerization of tetrafluoroethylene. With a linear molecular structure of repeating —CF2-CF3-units, PTFE is a crystalline polymer with a melting point of 327 degrees C. Density is 2.13 to 2.19 g/cc. PTFE's coefficient of friction is lower than almost any other known material. It is available in granular, fine powder (e.g., 0.2 micron), and water based dispersion forms. In the United States, PTFE is sold as “TEFLON” by Du Pont de Nemours Co.

The non-stick, anti-friction coating used in the method of the invention can be applied by spraying on as a dry powder, followed by heating to fix or cure the coating. The techniques used can vary from conventional air atomized spray coating using a spray gun to such techniques as electrostatic deposition.

For electrostatic deposition, individual particles of polymer powder are statically charged and applied to the gripping ring surfaces, preferably at ambient temperatures. The gripping ring exterior surfaces can be coated using a variety of manual and automatic electrostatic application equipment including electrostatic air atomized, airless, air-assisted airless and rotary atomized powder particles arc negatively charged by either direct contact charging or by high voltage ranges from 60,000 to 120,000 volts with very low electrical currents (100 to 200 microamperes). The negatively charged particles seek a positively grounded object to satisfy the negative charge potential. The electrostatic force is so great that powder particles traditionally lost by overspray and bounceback from conventional air-atomized spray are attracted to the grounded part.

The dry powders can also have a color additive, such as a suitable pigment, dispersed therein which impart a distinctive color to the coated region of the gasket. Color markings of this type can be used for product identification purposes, e.g., for use as a water pipe joint, a sewer pipe joint, etc.

After application of the dry powder to the substrate, the gripping ring will typically be heated, either reflectively or in an oven, to fix or set the coating. The exact temperature employed will depend upon the particular fluoropolymer chosen and the manufacturer's recommendation.

The preferred gripping ring which is illustrated has an inner circumferential surface 53 and an outer circumferential surface 55. The inner circumferential surface 55 has at least one row of teeth 59 located thereon for engaging selected points on the exterior surface of the mating male pipe 45. While the mating male pipe is shown as being formed of ductile iron in FIG. 1, it will be understood that the pipe could be formed of another suitable material, such as PVC or another plastic.

In the version of the device illustrated in FIG. 1, there are three rows of teeth formed on the inner circumferential surface 55 of the gripping ring 53. As will be apparent from FIG. 1, the teeth are formed on an acute angle “α” with respect to a horizontal axis (illustrated as 73 in FIG. 1) of the mouth opening once installed within the as-cast fitting 39. The shape and inclined angle of the teeth allow a mating male pipe end to be received within the end opening of the pipe/fitting 41 and move in a downward direction as viewed in FIG. 1. However, the shape and inclined angle of the teeth 59 resist opposite relative movement of the mating male pipe end 45 and thereby exert a restraining force on the mating male pipe once the male pipe has be fully inserted into the pipe/fitting and hydrostatic pressure is applied to the pipe joint. As can be seen in FIG. 1, the first recess 49 includes a tapered surface 50 which acts as a ramp surface with respect to the gripping ring 53 as pressure is applied to the pipe joint. In this manner, the tapered surface 50 allows the gripping ring to tighten around the mating pipe 45 as hydrostatic pressure is applied to the assembled joint, thus providing a restraining feature for the joint.

The gripping ring 53 is preferably formed as a single piece, continuous ring formed of a hard metal, such as steel which has a slit at one circumferential location which creates at least one gap, the gap being defined between two opposing faces of the gripping ring when the ring is in a relaxed state. The exact material characteristics for the ring and number and shape of the gripping teeth will be dictated by the material of the mating male pipe being gripped. For example, where the mating male pipe is formed of iron, the gripping ring maybe formed of hardened steel which has been heat treated to at least about 370 Brinell hardness (BHN) so that the teeth of the ring can penetrate the mating male iron pipe exterior surface or form a buttress on the pipe surface. In the case where the mating male pipe 45 is formed of plastic, such as from PVC, the ring can be manufactured as described in U.S. Pat. No. 7,125,054, issued Oct. 24, 2006, entitled “Self Restraining Gasket and Pipe Joint”, assigned to the assignee of the present invention.

The combination sealing and restraint system of the invention also includes a companion sealing gasket 61 having an annular gasket body at least a portion of which is made of a resilient elastomeric material. The annular gasket body having an inner circumferential region 63 and an outer circumferential region 65 and is installed within the second spaced recess 51 provided as a part of the as-cast profile within the mouth region of the ductile iron pipe/fitting. In this way, the outer circumferential region 65 forms a seal with the pipe/fitting mouth region and the inner circumferential region 63 forms a sealing surface for a mating male pipe section. The sealing gasket 61 is installed within the second spaced recess in a post-casting step after forming the pipe/fitting body.

Preferably, the sealing gasket 61 is a dual durometer gasket, such as the gasket shown in U.S. Pat. No. 5,213,339, issued May 25, 1993, to Walworth, and assigned to the assignee of the present invention. Dual durometer gaskets of this overall type will be familiar to those skilled in the relevant industries. The gasket shown in the '339 patent includes front and back regions, 67, 69, respectively, the front region 67 being resilient and relatively rigid, the back region 69 being softer and more resilient than the front region. An interior tip 71 of the back region sealingly engages the exterior surface of the mating male pipe. The exterior tip of the back region in cooperation with the front and back regions, both secures and seals the front and back regions within the profile provided in the pipe mouth region before the insertion of the mating male pipe.

The gasket 61 has a generally donut shape defining an aperture with distinct exterior and interior contours and is made from a suitable elastomer. The exterior contour is designed to have less curvature than the pipe profile at the end of the back region. When inserted into the pipe profile, the gasket is bent and forced to conform to the profile. The rigid front region 67 then forces the gasket radially outward against the pipe. Due to its resiliency, the conformed exterior surface exerts pressure on the profile thus keeping the gasket securely in place, and provides an initial seal against the outer pipe.

The interior contour further defines the aperture to have a smaller inside diameter at the soft back region than the inside diameter at the rigid front region. During the insertion process, the mating male pipe is centered by the back region and generally only makes contact with this conformable soft back region and not the rigid front region of the gasket 51. The inner pipe displaces the interior contour radially outward into the pipe profile, and forces the gasket to further conform. Again, due to its resiliency, the conformed gasket exerts pressure circumferentially around the inner pipe thus sealing the annular area which exists between the two pipes. When internal pressure or external forces act on the pipe joint, the gasket reacts dynamically by absorbing the internal or external load and in turn exerts more pressure on the pipe joint to preserve the integrity of the seal. Also, the lip region 71 of the inner circumferential region 63 forms a primary lip seal for engaging the mating male pipe end during insertion.

Although the preferred gasket illustrated in FIG. 1 is a dual durometer gasket, the combination sealing and restraint system could also utilize a single durometer gasket which is of a “snap-fit” variety. These types of gaskets have an embedded reinforcing ring which is not easily bent or flexed by hand and which is of a diameter which is generally greater than the diameter of the mouth opening of the as-cast pipe/fitting. An example of such a gasket can be seen in U.S. Pat. No. 6,044,539, issued Apr. 4, 2000, entitle “Pipe Gasket and Method of Installation”, assigned to the assignee of the present invention. Other sealing gasket designs could be utilized, as well, as long as they can be installed in the second recess 51 as described above.

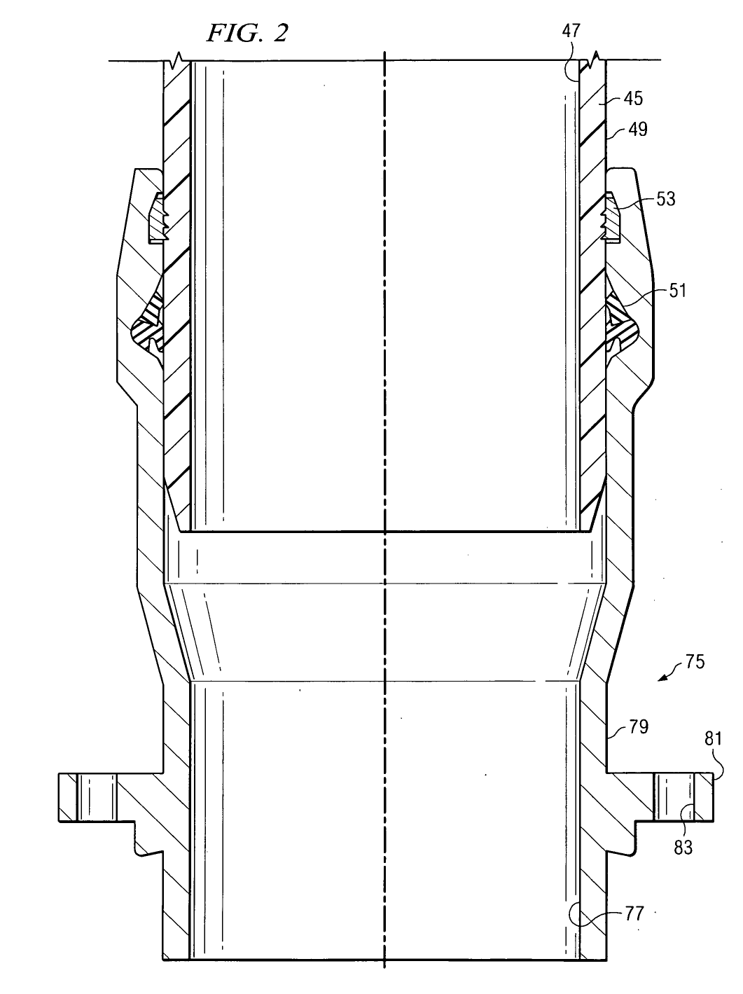

FIG. 2 of the drawings shows another form of the combination sealing and restraint system of the invention in which the pipe/fitting is provided in the form of an “adapter” 75. The adapter 75 can be used for connecting a traditional ductile iron mechanical joint to a mating male pipe section. The adapter version of the device of the invention has a generally cylindrical ductile iron adapter body having an interior surface 77 and an exterior surface 79. The interior surface 77 includes the previously described combination sealing and restraint system which is installed within an as-cast profile provided within a mouth region located adjacent an end opening of the adapter body capable of both sealing and restraining the adapter body to a mating male pipe having an interior surface and an exterior surface. In the case of the adapter 75, however, the generally cylindrical adapter body has an external flange ring 81 formed thereon as an integral part of the as-cast body of the adapter. The external flange ring 81 has a plurality of bolt openings 83 for receiving joining bolts which are used to join the adapter to a mating mechanical joint having a mating flange ring. For instance, with reference to the prior art mechanical joint shown in FIG. 3 of the drawings, the flange ring 81 could be joined to the flange ring 27 of the mechanical joint.

The operation of the combination sealing and restraint system of the invention will now be briefly described. As has been described, the gripping ring is installed within the mouth region of the pipe/fitting by compressing the ring, at least partly closing the ring gap, and inserting the ring into the previously cast first recess of the pipe/fitting. The sealing gasket is similarly installed in a post-casting operation. Because the sealing gasket is installed after the pipe has been cast, it must be capable of flexing or being contorted to at least some extent to make it be received within its respective profile. Once the sealing gasket is in place, the mating male pipe is installed within the end opening of the mouth region of the as-cast pipe/fitting by pushing the male pipe within the end opening. Upon insertion of the male pipe end, the sealing and restraint system contacts the external surface of the mating male pipe in order to both seal and restrain the mating male pipe and form a secure pipe joint.

An invention has been provided with several advantages. The combination sealing and restraint system of the invention is capable of joining and sealing an as-cast ductile iron pipe/fitting to a mating male pipe section. The same joint can be used for both ductile iron pipe and for PVC pipe by changing out the gripping ring. A heat treated and hardened ring will generally be used where the mating pipe is formed of ductile iron. The specially designed joint of the invention can be used as a restraining joint or, by leaving out the gripping ring, as a regular push-on joint without a restraining feature. Because the joint is an internal restraining joint, when assembled it has a smaller overall outside diameter than the existing external restraining joints used with pipe. When this new joint is used in conjunction with casing pipe, the smaller outside diameter of the joint will result in a smaller inside diameter casing pipe. An additional advantage of the adapter is that it can be used on existing MJ joint pipe/fittings and can be converted to a restraining joint for either ductile iron pipe or PVC pipe. The MJ end of the adapter allows it to be fitted to an MJ joint and the other end used for either ductile iron or PVC pipe.

The system of the invention is simple in design and relatively economical to manufacture. The improved profile design of the mouth region of the pipe/fitting involves only simple changes in the sand casting which is used to form the part during manufacturing. The present invention can be used to join ductile iron fittings to mating pipe sections without the need for external mechanical restraint components which complicate assembly and can be subject to corrosion or deterioration in use. Since the pipe assembly operation is a simple push-on style connection, the operation is easier to perform, thereby saving time and money as compared to the prior art mechanical joint type assembly.

While the invention has been shown in two of its forms, it is not thus limited but is susceptible to various changes and modifications without departing from the spirit thereof.

I claim:

1. A combination sealing and restraint system for installation within an as-cast profile provided within a mouth region located adjacent an end opening of a body of an as-cast ductile iron pipe/fitting capable of both sealing and restraining the ductile iron pipe/fitting to a mating male pipe having an interior surface and an exterior surface, the sealing and restraint system comprising:
a gripping ring installed within a first recess provided as a part of the as-cast profile of the ductile iron pipe/fitting, the gripping ring being installed in a post-casting step, the gripping ring having an inner circumferential surface and an outer circumferential surface, the inner circumferential surface having at least one row of teeth located thereon for engaging selected points on the exterior surface of the mating male pipe; and
a sealing gasket having an annular gasket body at least a portion of which is made of a resilient elastomeric material, the annular gasket body having an inner circumferential region and an outer circumferential region, the sealing gasket being installed within a second spaced recess provided as a part of the as-cast profile within the mouth region of the ductile iron pipe/fitting so that the outer circumferential region forms a seal with the fitting mouth region and the inner circumferential region forms a sealing surface for a mating male pipe section, the sealing gasket being installed within the second spaced recess in a post-casting step after forming the pipe/fitting body.

2. The combination sealing and restraint system of claim 1, wherein the sealing gasket is a dual durometer gasket.

3. The combination sealing and restraint system of claim 1, wherein the gripping ring is formed of metal which has been coated with a low-coefficient of friction coating.

4. The combination sealing and restraint system of claim 3, wherein the coating is a first layer of aan aqueous phenolic resin dispersion, which is then covered with a fluoroelastomer top coat.

5. The combination sealing and restraint system of claim 1, wherein the gripping ring is a single piece ring which has a slit at one circumferential location which creates at least one gap, the gap being defined between two opposing faces of the gripping ring when the ring is in a relaxed state, the gap being sufficient to allow the gripping ring to be placed on a die or tool during the casting operation.

6. The combination sealing and restraint system of claim 1, wherein the mating male pipe which is used with the restraint system of the invention is also made from iron.

7. The combination sealing and restraint system of claim 1, wherein the mating male pipe which is used with the restraint system of the invention is made from a plastic material.

8. The combination sealing and restraint system of claim 1, wherein the sealing gasket which is used with the restraint system of the invention is a snap-fit gasket having an embedded reinforcing ring which is not easily bent or flexed by hand and which is of a diameter which is generally greater than the diameter of the mouth opening of the as-cast pipe/fitting.

9. The combination sealing and restraint system of claim 1, wherein the mating male pipe is formed of iron and wherein the gripping ring is formed of hardened steel which has been heat treated to at least about 370 Brinell hardness (BHN) so that the teeth of the ring can penetrate the mating male iron pipe exterior surface or form a buttress on the pipe surface.

10. The combination sealing and restraint system of claim 1, wherein the sealing gasket is activated by internal hydraulic forces of fluids passing through the pipe/fitting body during use, the hydraulic forces also serving to cause the gripping teeth on the gripping ring to engage the exterior surface of the mating male pipe.

11. The combination sealing and restraint system of claim 1, wherein the pipe/fitting is part of a device selected from the group consisting of hydrant tees and flow line valves.

12. An adapter for connecting a ductile iron mechanical joint to a mating male pipe section, the adapter comprising:
a generally cylindrical ductile iron adapter body having an interior surface and an exterior surface, the interior surface including a combination sealing and restraint system which is installed within an as-cast profile provided within a mouth region located adjacent an end opening of the adapter body capable of both sealing and restraining the adapter body to a mating male pipe having an interior surface and an exterior surface;
the cylindrical adapter body having an external flange ring formed thereon as an integral part of the as-cast body of the adapter, the external flange ring having a plurality of bolt openings for receiving joining bolts which are used to join the adapter to a mating mechanical joint having a mating flange ring; and
wherein the sealing and restraint system which is installed within the mouth region of the adapter body includes a gripping ring installed within a first recess provided as a part of the as-cast profile of the adapter body, the gripping ring being installed in a post-casting step, the gripping ring having an inner circumferential surface and an outer circumferential surface, the inner circumferential surface having at least one row of teeth located thereon for engaging selected points on the exterior surface of the mating male pipe; and
a sealing gasket having an annular gasket body at least a portion of which is made of a resilient elastomeric material, the annular gasket body having an inner circumferential region and an outer circumferential region, the sealing gasket being installed within a second spaced recess provided as a part of the as-cast profile within the mouth region of the adapter body so that the outer circumferential region forms a seal with the fitting mouth region and the inner circumferential region forms a sealing surface for a mating male pipe section, the sealing gasket being installed within the second spaced recess in a post-casting step after forming the adapter body.

13. The adapter of claim 12, wherein the sealing gasket is a dual durometer gasket.

14. The adapter of claim 12, wherein the gripping ring is a single piece ring which has a slit at one circumferential location which creates at least one gap, the gap being defined between two opposing faces of the gripping ring when the ring is in a relaxed state, the gap being sufficient to allow the gripping ring to be placed on a die or tool during the casting operation.

15. The adapter of claim 12, wherein the mating male pipe which is used with the restraint system of the invention is also made from iron.

16. The adapter of claim 12, wherein the mating male pipe which is used with the restraint system of the invention is made from a plastic material.

17. The adapter of claim 12, wherein the sealing gasket which is used with the restraint system of the invention is a snap-fit gasket having an embedded reinforcing ring which is not easily bent or flexed by hand and which is of a diameter which is generally greater than the diameter of the mouth opening of the as-cast pipe/fitting.

18. The adapter of claim 12, wherein the mating male pipe is formed of iron and wherein the gripping ring is formed of hardened steel which has been heat treated to at least about 370 Brinell hardness (BHN) so that the teeth of the ring can penetrate the mating male iron pipe exterior surface or form a buttress on the pipe surface.

19. The adapter of claim 11, wherein the sealing gasket is activated by internal hydraulic forces of fluids passing through the pipe/fitting body during use, the hydraulic forces serving to cause the gripping teeth on the gripping ring to engage the exterior surface of the mating male pipe.

20. The adapter of claim 11, wherein the pipe/fitting is part of a device selected from the group consisting of hydrant tees and flow line valves.

21. A method of forming a pipe joint, the method comprising the steps of:
providing a fluid piping system including at least one as-cast ductile iron pipe/fitting, previously cast at a foundry, having a mouth region adjacent an end opening thereof, the mouth region having an as-cast profile formed therein, the end opening of the pipe/fitting being sized to receive a mating male pipe having an interior surface and an exterior surface;
including a combination sealing and restraint system which is installed within the as-cast profile provided within the mouth region of the pipe/fitting which is capable of both sealing and restraining the pipe/fitting to a mating male pipe having an interior surface and an exterior surface;
wherein the sealing and restraint system which is installed within the mouth region of the pipe/fitting includes a gripping ring installed within a first recess provided as a part of the as-cast profile of the adapter body, the gripping ring being installed in a post-casting step, the gripping ring having an inner circumferential surface and an outer circumferential surface, the inner circumferential surface having at least one row of teeth located thereon for engaging selected points on the exterior surface of the mating male pipe;
wherein the sealing and restraint system also includes a sealing gasket having an annular gasket body at least a portion of which is made of a resilient elastomeric material, the annular gasket body having an inner circumferential region and an outer circumferential region, the sealing gasket being installed within a second spaced recess provided as a part of the as-cast profile within the mouth region of the pipe/fitting so that the outer circumferential region forms a seal with the fitting mouth region and the inner circumferential region forms a sealing surface for a mating male pipe section, the sealing gasket being installed within the second spaced recess in a post-casting step after forming the pipe/fitting; and
thereafter installing a mating male pipe within the end opening of the mouth region of the as-cast pipe/fitting by pushing the male pipe within the end opening, the sealing ring and gripping ring contacting the external surface of the mating male pipe in order to both seal and restrain the mating male pipe and form a secure pipe joint.

22. The method of claim 21, wherein the pipe/fitting comprises a cylindrical adapter body having an external flange ring formed thereon as an integral part of the as-cast body of the adapter, the external flange ring having a plurality of bolt openings for receiving joining bolts which are used to join the adapter to a mating mechanical joint having a mating flange ring.

23. The method of claim 22, wherein the adapter body is bolted to an existing ductile iron mechanical joint and thereafter a mating male pipe end is inserted within the mouth opening of the adapter to form a secure joint.
